(19) United States
(12) Patent Application Publication
(10) Pub. No.: US 2017/0218908 A1
(43) Pub. Date: Aug. 3, 2017

(54) FUEL INJECTION VALVE AND FUEL INJECTION SYSTEM

(71) Applicant: Robert Bosch GmbH, Stuttgart (DE)

(72) Inventors: Kaoru Maeda, Kanagawa (JP); Sebastian Wieschollek, Farmington Hills, MI (US); Thomas Stach, Farmington Hills, MI (US)

(21) Appl. No.: 15/416,960

(22) Filed: Jan. 26, 2017

(30) Foreign Application Priority Data
Jan. 29, 2016 (JP) 2016-015108

(51) Int. Cl. F02M 61/16; F02M 61/14; F02F 1/24; F02M 55/00; F02M 51/00; F02M 51/06

(52) U.S. Cl. CPC F02M 61/167; F02M 61/166; F02M 51/005; F02M 51/06; F02F 1/242; F02M 55/005; F02M 61/14

(57) ABSTRACT

In a fuel injection valve that is inserted along a shape of an attachment hole formed in a cylinder head and that directly injects fuel supplied from a fuel supply section into a combustion chamber via a stepped section, the fuel supply section includes: a fuel cup, an end of which has a tapered section; a seal ring that prevents leakage of the fuel to the outside; and a support ring that supports the seal ring, the stepped section includes: a nozzle that injects the fuel into the combustion chamber; and an attachment shaft that has a larger radius than the nozzle, and a first gap in an axial direction between the tapered section and the support ring is larger than a second gap in the axial direction between the attachment hole and the attachment shaft.

### BACKGROUND OF THE INVENTION

The invention relates to a fuel injection valve and a fuel injection system and is particularly suited for application to a fuel injection valve and a fuel injection system that directly inject high-pressure fuel into a combustion chamber in a cylinder.

Conventionally, a fuel injection valve is configured by including a compensation element. This compensation element compensates for an angular deviation between an axis of a fuel injection valve and an axis of an attachment hole formed in a cylinder head when the fuel injection valve is attached to the cylinder head of a fuel injection system.

Accordingly, even when the axis of the fuel injection valve is slightly deviated from the axis of the attachment hole during attachment, the fuel injection valve can appropriately be attached to the attachment hole. Note that this deviation during the attachment is resulted from a manufacturing error generated in manufacturing processes of the fuel injection valve and the cylinder head.

The invention related to a structure of this compensation element is disclosed in JP-T-2004-506136. More specifically, the disclosed compensation element is configured by including: a first rigid ring; a second rigid ring; and an intermediate elastic ring that is provided between the first ring and the second ring.

According to this JP-T-2004-506136, a point of center of the first ring can move in a radial direction with respect to a point of center of the second ring due to elastic deformation of the intermediate ring. In addition, a tilt and movement in an axial direction of the fuel injection valve are each compensated in a wide range. Thus, even when the deviation during the attachment is significant, such an error can be compensated.

In general, the compensation element includes a rigid member such as a metal. The fuel injection valve and the cylinder head also include rigid members such as metals. The fuel injection valve is supported by the compensation element, and the compensation element is supported by the cylinder head. Thus, the metals are in direct contact with each other in an attached state of the fuel injection valve.

In such a case, drive noise of the fuel injection valve is likely to be transmitted to the cylinder head, which raises a problem of degraded comfortability (NVH: Noise, Vibration, and Harshness) of an automobile.

In view of the above, use of a compensation element that is molded from a thermoplastic resin, such as plastic, has been examined in recent years for a purpose of improving NVH. In the case where the compensation element is molded from the plastic, the drive noise of the fuel injection valve is less likely to be transmitted to the cylinder head. Thus, NVH can be improved. In addition, compared to a case where the compensation element is made of the metal, the compensation element that is molded from the plastic can be manufactured at low cost. Thus, manufacturing cost can be cut.

Meanwhile, such a new problem is raised that durability of the compensation element that is molded from the plastic is lower than that of the compensation element made of the metal. The compensation element that is molded from the plastic is possibly melted when being exposed to a high temperature, and is possibly fractured when receiving a significant impact.

For example, in the cases where a gas seal ring is fractured due to some reason, combustion gas generated in a combustion chamber enters from the attachment hole, and the compensation element is exposed to the high-temperature combustion gas, a part or a whole of the compensation element is possibly melted.

In such a case, the fuel injection valve moves to the combustion chamber side in the axial direction for a distance corresponding to the melted part of the compensation element. As a result, a fitted state between a fuel cup that guides the fuel and a connection pipe that is connected to the fuel cup is canceled or loosened, and some of the fuel is leaked to the outside. Therefore, the compensation element that is molded from the plastic has a problem of degraded safety.

### SUMMARY OF THE INVENTION

The invention has been made in consideration of the above points and therefore proposes a fuel injection valve and a fuel injection system capable of maintaining safety while improving comfortability.

In order to solve the above problem, the invention is a fuel injection valve (10) that is inserted along a shape of an attachment hole (21) formed in a cylinder head (20) and that directly injects fuel supplied from a fuel supply section (A1) into a combustion chamber (30) via a stepped section (B1). In the fuel injection valve (10), the fuel supply section (A1) includes: a fuel cup (11), an end of which has a tapered section (111); a seal ring (12) that prevents leakage of the fuel to the outside; and a support ring (13) that supports the seal ring (12), the stepped section (B1) includes: a nozzle (15) that injects the fuel into the combustion chamber (30); and an attachment shaft (16) that has a larger radius than the nozzle (15), and a first gap (G1) in an axial direction (D1) between the tapered section (111) and the support ring (13) is larger than a second gap (G2) in the axial direction (D1) between the attachment hole (21) and the attachment shaft (16).

According to the invention, safety can be maintained while comfortability can be improved.

### BRIEF DESCRIPTION OF THE DRAWINGS

FIG. 1 is an overall configuration diagram of a fuel injection system;

FIG. 2 is an enlarged configuration diagram of a fuel supply section;

FIG. 3 is an enlarged configuration diagram of a stepped section;

FIG. 4 is an enlarged configuration diagram that depicts states of a fuel injection valve before and after movement; and

FIG. 5 is an enlarged configuration diagram of another stepped section.

### DETAILED DESCRIPTION

A detailed description will hereinafter be made on an embodiment of the invention with reference to the drawings provided below.

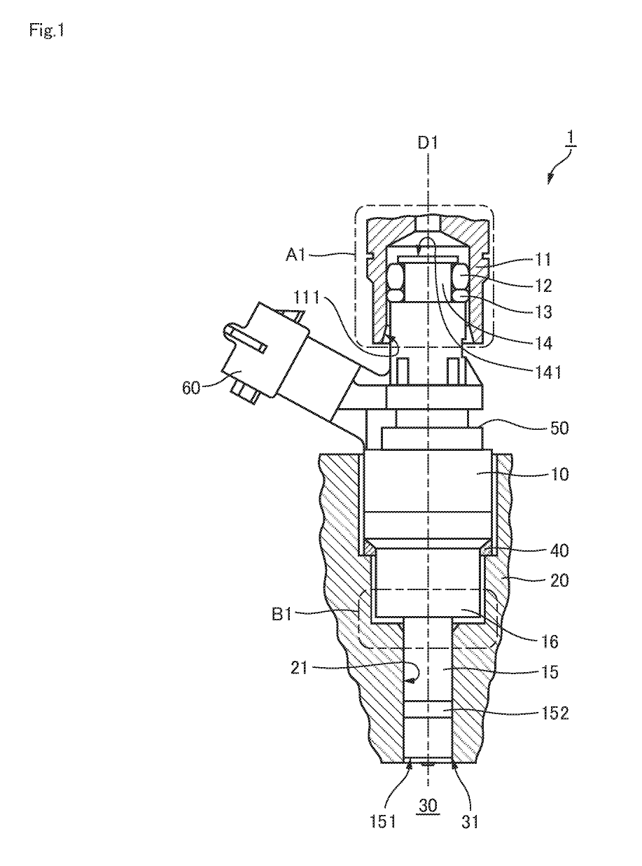

FIG. 1 depicts an overall configuration of a fuel injection system 1 according to this embodiment. The fuel injection system 1 includes a fuel injection valve 10, a cylinder head 20, a combustion chamber 30, and the like. The fuel injection valve 10 is inserted and attached along a shape of an attachment hole 21 that is formed in the cylinder head 20, and directly injects fuel supplied from a fuel supply section A1 to the combustion chamber 30 via a stepped section B1.

A description will hereinafter be made on a configuration of each section provided in the fuel injection valve 10.

The fuel supply section A1 includes a fuel cup 11, a seal ring 12, a support ring 13, and a connection pipe 14. The fuel cup 11 is a member that guides the fuel to an opening 141 of the connection pipe 14.

A tapered section 111 in a tapered shape is formed at an end of the fuel cup 11. Due to formation of this tapered section 111, the connection pipe 14 can easily be inserted in the fuel cup 11.

The seal ring 12 is a member that prevents the fuel guided by the fuel cup 11 from being unguided to the connection pipe 14 and leaked to the outside. The seal ring 12 is an O-ring that is made of an elastic member such as rubber, for example.

The support ring 13 is a member that supports the seal ring 12 with a uniform force. This support ring 13 is attached immediately below the seal ring 12 and thereby refrains from supporting the seal ring 12 with an uneven force even when the connection pipe 14 moves in an axial direction D1, for example.

More specifically, in the case where high-pressure fuel acts on the seal ring 12, the support ring 13 reduces a diametrical clearance between the seal ring 12 and the fuel cup 11, and prevents protrusion of the seal ring 12 when the seal ring 12 is the O-ring that is made of the elastic member such as the rubber. In this way, the support ring 13 prevents a fracture of the seal ring 12.

When the diametrical clearance is expanded, the seal ring 12 is supported with the uneven force. In this case, a locally intense force is applied to the seal ring 12, which possibly leads to the fracture of the seal ring 12. The support ring 13 is a member that prevents such a problem.

The connection pipe 14 is a member that is connected to the fuel cup 11, and the opening 141 has a flange shape. When the connection pipe 14 is inserted in and connected to the fuel cup 11, the connection pipe 14 is inserted in a state where the seal ring 12 and the support ring 13 are attached thereto in advance.

The stepped section B1 includes a nozzle 15 and an attachment shaft 16. The nozzle 15 is a member that actually injects the fuel from the fuel supply section A1 into the combustion chamber 30. An end 151 thereof on the combustion chamber 30 side in the axial direction D1 is configured to be formed with plural injection holes.

The nozzle 15 also includes a gas seal ring 152. The gas seal ring 152 is a member that fills a clearance 31 produced between the nozzle 15 and the attachment hole 21. The gas seal ring 152 is a Teflon™ ring made of a fluorocarbon resin, for example.

The attachment shaft 16 is configured to have a larger radius than the nozzle 15. A step is thereby formed.

A compensation element 40 is a member that compensates for a manufacturing error of the fuel injection valve 10 or the attachment hole 21, and is herein molded from a thermoplastic resin that is melted when being heated. Note that the thermoplastic resin is generally referred to as plastic. By adopting the plastic as a material of the compensation element 40, the compensation element 40 can easily be molded at low cost when compared to a case where a metal is adopted.

A pressing member 50 is a member that holds down the fuel injection valve 10 to the combustion chamber 30 side in the axial direction D1, so as to hold the fuel injection valve 10 in the attachment hole 21. A connection connector 60 is a member that connects a connection line to the fuel injection valve 10, the connection line electrically controlling an operation of the fuel injection valve 10.

Next, a description will be made on the operation of the fuel injection valve 10 in the case where malfunction of the gas seal ring 152 occurs. As described above, the gas seal ring 152 is the member that fills the clearance 31. This gas seal ring 152 can usually prevent entry of combustion gas through the clearance 31.

However, in the case where the gas seal ring 152 is melted, fractured, or the like due to some reason, the combustion gas generated in the combustion chamber 30 enters through the clearance 31. In this case, the fuel injection valve 10 is exposed to the high-temperature combustion gas. In the case where the compensation element 40 is molded from the plastic, which is the thermoplastic resin, this compensation element 40 is thereafter melted.

As a result, the fuel injection valve 10 moves to the combustion chamber 30 side in the axial direction D1 for a distance corresponding to a melted part of the compensation element 40. At this time, only the fuel cup 11 is fixed at a position in the axial direction D1 by a member, which is not depicted. Accordingly, a fitted state between the fuel cup 11 and the connection pipe 14 is canceled, and the fuel supplied from the fuel cup 11 is possibly leaked to the outside.

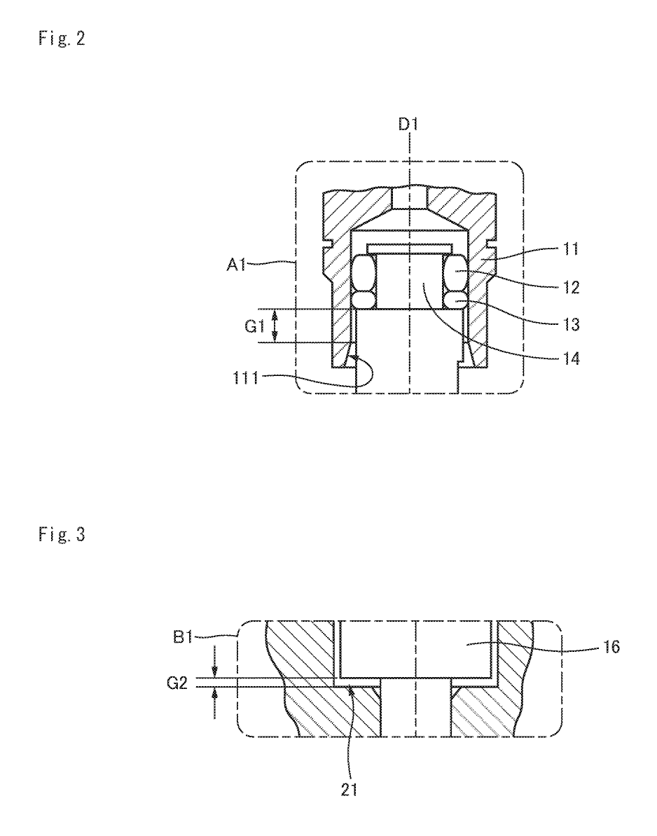

In this embodiment, even in the cases where the compensation element 40 is melted and the fuel injection valve 10 moves to the combustion chamber 30 side in the axial direction D1, just as described, it is attempted to reliably prevent the fuel from the fuel cup 11 from being leaked to the outside. For this reason, gaps (FIG. 2 and FIG. 3) are defined in this embodiment.

FIG. 2 is an enlarged configuration diagram of the fuel supply section A1. A first gap G1 that is defined in the fuel supply section A1 is a distance in the axial direction D1 between an end of the tapered section 111 on the support ring 13 side among both ends of the tapered section 111 and an end surface of the support ring 13 on the tapered section 111 side among both end surfaces of the support ring 13.

FIG. 3 is an enlarged configuration diagram of the stepped section B1. A second gap G2 that is defined in the stepped section B1 is a distance in the axial direction D1 between an opposing surface of the attachment hole 21 that opposes the attachment shaft 16 in the axial direction D1 among surfaces of the attachment hole 21 and an opposing surface of the attachment shaft 16 that opposes the attachment hole 21 in the axial direction D1 among surfaces of the attachment shaft 16.

Here, in the case where the first gap G1 is too small, the support ring 13 is expanded in a radial direction along a tapered shape of the tapered section 111 even when the connection pipe 14 slightly moves downward. In the case where the support ring 13 is expanded in the radial direction, the diametrical clearance is expanded, and the seal ring 12 is no longer uniformly supported by the support ring 13. As a result, the local force is applied to the seal ring 12, which causes tearing thereof. Thus, the fuel is possibly leaked to the outside. For the above reason, certain length of the distance is required for the first gap G1.

In view of the above, a relationship between the first gap G1 and the second gap G2 is defined to satisfy the first gap G1>the second gap G2 in this embodiment. In this way, even in the cases where the compensation element 40 is melted and the connection pipe 14 moves to the combustion chamber 30 side in the axial direction D1, maximum displacement of the connection pipe 14 can be equal to the second gap G2.

In this case, the support ring 13 does not move to a position of the tapered section 111, and the seal ring 12 is uniformly supported by the support ring 13 at any time. Thus, the local force is not applied to the seal ring 12, and the fracture of the seal ring 12 can thereby be prevented. Therefore, the leakage of the fuel can reliably be prevented.

Meanwhile, the second gap G2 is defined to satisfy the second gap G2>0. In this way, direct contact of the fuel injection valve 10 with the cylinder head 20 can be prevented in a normal time. That is, direct contact of the metals can be prevented. Thus, drive noise of the fuel injection valve 10 is less likely to be transmitted to the cylinder head 20, and NVH can be improved.

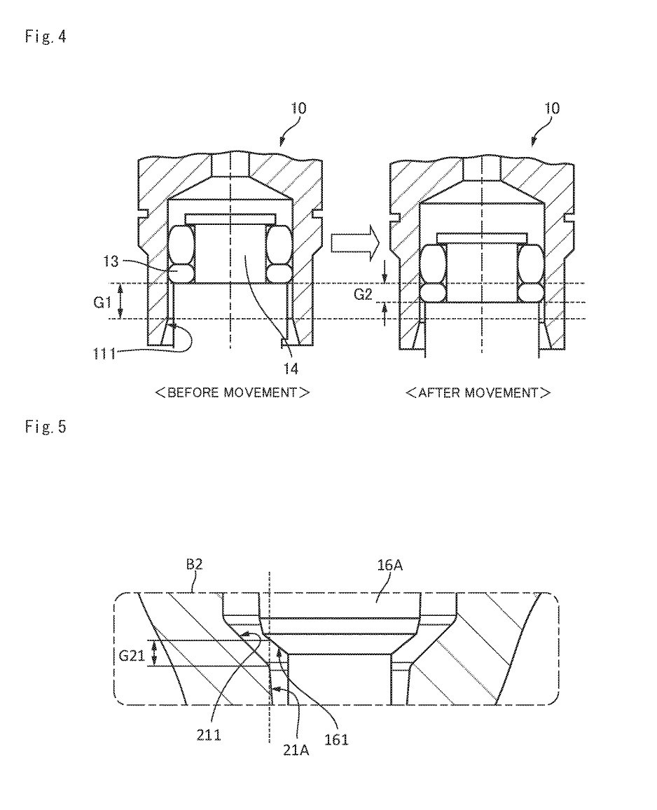

FIG. 4 depicts the fuel injection valve 10 before and after movement. The fuel injection valve 10 before the movement is configured by having the first gap G1 as the distance in the axial direction D1 between the end of the tapered section 111 and the end surface of the support ring 13. The fuel injection valve 10 (the connection pipe 14) possibly moves to the combustion chamber 30 side in the axial direction D1 due to some reason.

However, even in such a case, because the first gap G1>the second gap G2 is defined in this embodiment, the maximum displacement of the connection pipe 14 corresponds to the second gap G2. Accordingly, the distance in the axial direction D1 between the end of the tapered section 111 and the end surface of the support ring 13 is at least maintained to be a distance of (the first gap G1)−(the second gap G2).

As it has been described so far, according to this embodiment, the first gap G1 and the second gap G2 are defined to satisfy as the first gap G1>the second gap G2. Thus, even in the case where the connection pipe 14 moves downward in the axial direction D1, a position of the bottom surface of the support ring 13 can be maintained to be higher than the end of the tapered section 111 in the axial direction D1. In this case, the support ring 13 can support the seal ring 12 with the uniform force at any time, and thus can prevent the fracture of the seal ring 12. In this way, safety can be maintained.

FIG. 5 depicts an enlarged configuration of another stepped section B2. The other stepped section B2 differs from the stepped section B1 in a point that an attachment hole 21A and an attachment shaft 16A are respectively formed with a tapered section 211 and a tapered section 161, each of which has a tapered shape.

In this case, a second gap G21 is the shortest distance in the axial direction D1 between an opposing surface of the tapered section 211 of the attachment hole 21A that opposes the tapered section 161 of the attachment shaft 16A and an opposing surface of the tapered section 161 of the attachment shaft 16A that opposes the tapered section 211 of the attachment hole 21A.

The second gap G21 is defined just as described, and the first gap G1>the second gap G21 is defined as described above. In this way, even in the case where the compensation element 40 is melted and the connection pipe 14 moves downward in the axial direction D1, the maximum displacement of the connection pipe 14 can be equal to the second gap G21.

Accordingly, the supporting 13 does not move to the position of the tapered section 111, and the seal ring 12 is uniformly supported by the support ring 13 at any time. Thus, application of the locally intense force on the seal ring 12 and the fracture of the seal ring 12 can be prevented.

Alternatively, a distance (that is, thickness) of the compensation element 40 in the axial direction D1 may be defined as a third gap G3, and the first gap G1 or the third gap G3<the second gap G2 or G21 may be defined. In this case, even in the cases where the compensation element 40 is melted and the connection pipe 14 moves downward in the axial direction D1, the maximum displacement of the connection pipe 14 can be equal to the third gap G3. Thus, the position of the bottom surface of the support ring 13 can be maintained to be higher than the end of the tapered section 111 in the axial direction D1.

What is claimed is:

1. A fuel injection valve (10) that is inserted along a shape of an attachment hole (21) formed in a cylinder head (20) and that directly injects fuel supplied from a fuel supply section (A1) into a combustion chamber (30) via a stepped section (B1), wherein
the fuel supply section (A1) includes:
a fuel cup (11), an end of which has a tapered section (111);
a seal ring (12) that prevents leakage of the fuel to outside; and
a support ring (13) that supports the seal ring (12),
the stepped section (B1) includes:
a nozzle (15) that injects the fuel into the combustion chamber (30); and
an attachment shaft (16) that has a larger radius than the nozzle (15), and
a first gap (G1) in an axial direction (D1) between the tapered section (111) and the support ring (13) is larger than a second gap (G2) in the axial direction (D1) between the attachment hole (21) and the attachment shaft (16).

2. The fuel injection valve according to claim 1, wherein
the first gap (G1) is a distance in the axial direction (D1) between an end of the tapered section (111) on a support ring side among both ends of the tapered section (111) and an end surface of the support ring (13) on a tapered section side among both end surfaces of the support ring (13), and
the second gap (G2) is a distance in the axial direction (D1) between an opposing surface of the attachment hole (21) that opposes the attachment shaft (16) in the axial direction (D1) among surfaces of the attachment hole (21) and an opposing surface of the attachment shaft (16) that opposes the attachment hole (21) in the axial direction (D1) among surfaces of the attachment shaft (16).

3. The fuel injection valve according to claim 1, wherein
the first gap (G1) is a distance in the axial direction (D1) between an end of the tapered section (111) on a support ring side among both ends of the tapered section (111) and an end surface of the support ring (13) on a tapered section side among both end surfaces of the support ring (13), and
in a case where the attachment hole (21A) and the attachment shaft (16A) respectively have tapered sections (211, 161), the second gap (G21) is the shortest distance in the axial direction (D1) between an opposing surface of the tapered section (211) of the attachment hole (21A) that opposes the tapered section (161) of the attachment shaft (16A) and an opposing surface of the tapered section (161) of the attachment shaft (16A) that opposes the tapered section (211) of the attachment hole (21A).

4. The fuel injection valve according to claim 1, wherein
the second gap (G2, G21) is larger than zero.

5. The fuel injection valve according to claim 1 further comprising:
a compensation element (40) that compensates for an attachment error between the fuel supply section (A1) and the stepped section (B1), wherein
the compensation element (40) is a thermoplastic resin.

6. The fuel injection valve according to claim 5, wherein
the first gap (G1) is larger than a thickness of the compensation element (40).

7. A fuel injection system (1) including a fuel injection valve (10) that is inserted along a shape of an attachment hole (21) formed in a cylinder head (20) and that directly injects fuel supplied from a fuel supply section (A1) into a combustion chamber (30) via a stepped section (B1), wherein
the fuel supply section (A1) includes:
a fuel cup (11), an end of which has a tapered section (111);
a seal ring (12) that prevents leakage of the fuel to outside; and
a support ring (13) that supports the seal ring (12),
the stepped section (B1) includes:
a nozzle (15) that injects the fuel into the combustion chamber (30); and
an attachment shaft (16) that has a larger radius than the nozzle (15), and
a first gap (G1) in an axial direction (D1) between the tapered section (111) and the support ring (13) is larger than a second gap (G2) in the axial direction (D1) between the attachment hole (21) and the attachment shaft (16).
